(19) United States
(12) Patent Application Publication
(10) Pub. No.: US 2005/0227708 A1
(43) Pub. Date: Oct. 13, 2005

(54) MP3 broadcasting device with cigarette-lighter plug

(76) Inventor: Morris Peng, Tu Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/822,738

(22) Filed: Apr. 13, 2004

(51) Int. Cl. H04B 1/00

(52) U.S. Cl. 455/456.1

(57) ABSTRACT

AN MP3 broadcasting device, which can be used via plugging in a cigarette-lighter socket inside a car, has a cigarette-lighter plug, a frequency modulation (FM) radio module, a transmission module, a playing module, a control module and a frequency-setting module. The cigarette-lighter plug is used to obtain a first electric power from the cigarette-lighter socket and convert the first electric power into a second electric power suitable for the MP3 broadcasting device. The transmission module is used to connect with an external electronic device capable of outputting music signals to obtain the music signals. The playing module is used to process and play the received music signals, and then transmits the playing music via the FM radio module. Therefore, a user can use a radio inside the car to listen to music transmitted by the MP3 broadcasting device.

### FIELD OF THE INVENTION

The present invention is directed to an MP3 broadcasting device with a cigarette-lighter plug, and more particularly, to an electronic device that can radio the playing music.

### BACKGROUND OF THE INVENTION

Recently, the electronic products are developed to be light, thin, short and small. The popular pen driver is one of the examples. Since it has small volume and large memory capacity, it has already replaced the traditional floppy disk. Via combining other functions, the pen driver can also be used to record sounds, receive broadcasting, play MP3 music files and so on.

Since the pen driver can be used to store data and play music simultaneously, a user can use it to store and play his favorite MP3 music files. The user usually uses earphones or a speaker to listen to music played by the pen driver via the output outlet of the pen driver. However, the earphones or speaker should connect with the pen driver via the output outlet by a connecting wire.

As described above, the user always needs to use a connecting wire when listening to music with the pen driver. It usually causes the user inconvenience while listening to music. Hence, if the inconvenience caused by the connecting wire can be overcome, it will be more comfortable for the user to listen to music with the pen driver.

Accordingly, the conventional pen drivers still have some drawbacks that could be improved. The present invention aims to resolve the drawbacks in the prior art.

### SUMMARY OF THE INVENTION

An objective of the present invention is to provide an MP3 broadcasting device with a cigarette-lighter plug, which can radio music for a user to hear by a radio.

Another objective of the present invention is to provide an MP3 broadcasting device with a cigarette-lighter plug, which doesn't need a battery inside. Hence, it can be made compact.

For reaching the objective above, the present invention provides an MP3 broadcasting device with a cigarette-lighter plug, which is engaged with a cigarette-lighter socket inside a car and externally connected to an electronic device. The MP3 broadcasting device comprises a cigarette-lighter plug for engaging with the cigarette-lighter socket to acquire a first electric power, a transmission module for receiving a first music signal output from the electronic device, a playing module for processing the first music signal to output a second music signal capable of being heard and a frequency modulation (FM) radio module for transmitting the second music signal.

The used frequency of the FM radio module can be set by using a frequency-setting module so as to avoid interferences from radio stations.

Furthermore, the playing module 16 can perform the functions of play, stop, fast forward (FF), fast rewind (FR), repeat or random play according to commands sent from the control module 17.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an elevational diagram of an MP3 broadcasting device with a cigarette-lighter plug in accordance with the present invention;

FIG. 2 is a block diagram of the MP3 broadcasting device with the cigarette-lighter plug in accordance with the present invention; and

FIG. 3 is a diagram illustrating use of the MP3 broadcasting device with the cigarette-lighter plug in accordance with the present invention.

### DETAILED DESCRIPTION

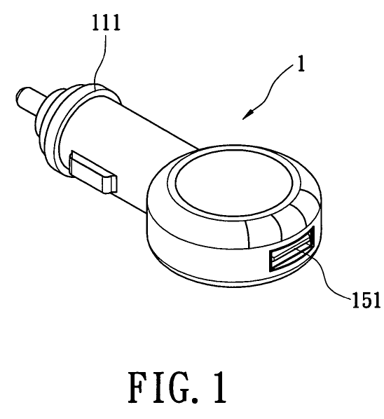

Reference is made to FIG. 1, which is an elevational diagram of an MP3 broadcasting device with a cigarette-lighter plug in accordance with the present invention. As shown in FIG. 1, the MP3 broadcasting device 1 employs a plug interface 111 disposed in its front end to engage with a cigarette-lighter socket inside a car so as to obtain electric power. Hence, the inside of the MP3 broadcasting device 1 doesn't need a battery.

Further, a connecting interface 151 disposed in the rear end of the MP3 broadcasting device 1 can connect with an electronic device that can output music signals. Hence, the MP3 broadcasting device 1 can acquire music signals from outside and then play and transmit the music via its inside circuit. A user can listen to music via the radio signals sent from the MP3 broadcasting device 1 with a radio device. Hence, the present invention can overcome the inconvenience resulted from the wired transmission of the prior art.

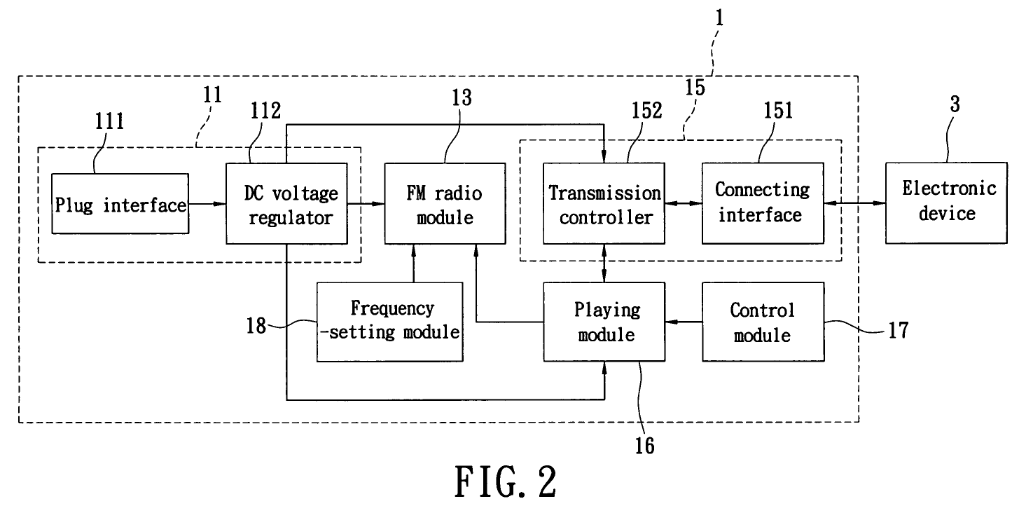

As described above, the functions of the MP3 broadcasting device 1 with the cigarette-lighter plug has been disclosed roughly. Regarding the detailed techniques, reference is made to FIG. 2, which is a block diagram of the MP3 broadcasting device with the cigarette-lighter plug in accordance with the present invention. The MP3 broadcasting device 1 includes: a cigarette-lighter plug 11, a frequency modulation (FM) radio module 13, a transmission module 15, a playing module 16, a control module 17 and a frequency-setting module 18.

The cigarette-lighter plug 11 can provide the electric power to the MP3 broadcasting device 1. The cigarette-lighter plug 11 has a plug interface 111 and a direct current (DC) voltage regulator 112. The plug interface 111 is a cigarette-lighter plug preferably and can be plugged into a cigarette-lighter socket inside a car to obtain electric power. The DC voltage regulator 112 is used to lower the DC voltage provided by the cigarette-lighter socket so as to provide a suitable electric power to the MP3 broadcasting device 1.

The transmission module 15 is used to connect to an electronic device 3 capable of outputting music signals, e.g. a pen driver or an MP3 playing device. The electronic device 3 has music files stored inside and the output music signals can be transmitted to the inside of the MP3 broadcasting device 1 via the transmission module 15.

The transmission module 15 has a transmission controller 152 and a connecting interface 151. The connecting interface 151 is a universal serial bus (USB) preferably, but is not limited thereto; i.e., it can also be other types of buses such as an Institute of Electrical and Electronic Engineer 1394 (IEEE 1394) bus. The transmission controller 152 can be used to control the connecting interface 151 to access the electronic device 3. The transmission controller 152 is preferably an OTG chip or host controller of the USB or IEEE1394 control chip.

The playing module 16 is used to receive the music signals sent from the transmission module 15. Since the received music signals are digital, the playing module 16 will convert the digital music signals into analog music signals capable of being heard. In the embodiment, the playing module 16 is preferably an MP3 decoder able to play the music files with an MP3/WMA format. The playing module 16 can perform functions of play, stop, fast forward (FF), fast rewind (FR), repeat or random play according to commands sent from the control module 17.

In order to broadcast the music output from the playing unit 16, in this embodiment, the FM radio module 13 is used to receive the music signals sent from the playing module 16 and radio the music signals via a specific frequency. The FM radio module 13 is preferably an FM transmission chip, which employs FM stereo signals to carry the music signals sent from the playing module 16 to provide better tone quality. In order to avoid radio bandwidths occupied by radio stations, the frequency-setting module 18 can be used to adjust the frequency used by the FM radio module 13. Hence, the FM radio module 13 can use the preset frequency to radio the music signals. The preset frequency is preferably located within 87.7-88.9 MHz or 106.7-107.9 MHz.

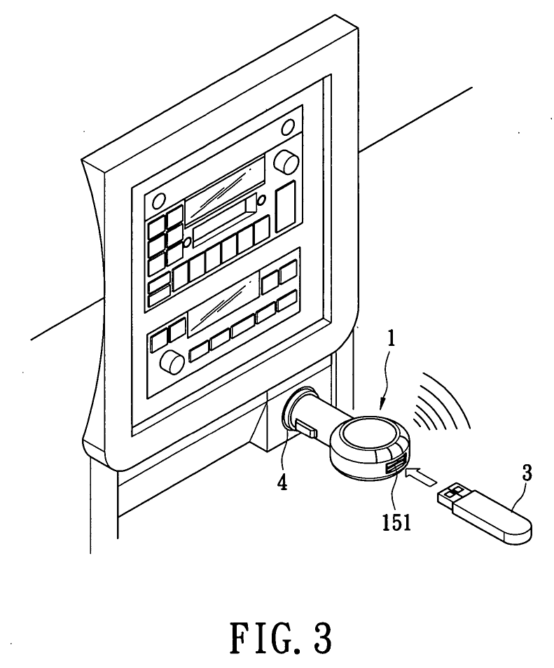

Reference is made to FIG. 3, which is a diagram illustrating use of the MP3 broadcasting device with the cigarette-lighter plug in accordance with the present invention. Summing up, the MP3 broadcasting device 1 is applied inside a car and plays music via the radio of the car. Initially, the MP3 broadcasting device 1 is plugged into the cigarette-lighter socket 4 of the car via the plug interface 111 to obtain the DC electric power and connected with an electronic device 3 via the connecting interface 151, which can be a pen driver capable of outputting music signals.

Consequently, after obtained the electric power and music signals, a user can use the control module 17 of the MP3 broadcasting device 1 to broadcast the music. Then, the FM radio module 13 will transmit the music signals. Subsequently, the user can turn on the radio of the car and tune it to the preset frequency set in the frequency-setting module 18 to receive the music signals sent from the MP3 broadcasting device 1 in a wireless manner and play the music. Of course the user can also use headphones with a radio receiver to listen to music broadcasted by the MP3 broadcasting device 1. Further, in addition to the pen driver, the music signals can be provided by an MP3 playing device.

Therefore, the MP3 broadcasting device of the present invention has the following features:

1. Providing a wireless playing device, which broadcasts the playing music signals via electric waves that can be received by a radio device. Hence, the inconvenience resulting from playing music via wired transmission can eliminated.

2. The device can be compact since it acquires the electric power externally and hence needn't have a battery inside.

3. The broadcasted frequency can be set flexibly to avoid interference from other radio stations.

4. Providing a friendly connecting interface to obtain the music signals e.g. USB connecting interface, which can connect with various USB electronic devices.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. AN MP3 broadcasting device, which is plugged into a cigarette-lighter socket inside a car and externally connected with an electronic device, the MP3 broadcasting device comprising:
a cigarette-lighter plug for plugging into the cigarette-lighter socket to acquire a first electric power;
a transmission module for receiving a first music signal output from the electronic device;
a playing module for processing the first music signal to output a second music signal capable of being heard; and
a frequency modulation (FM) radio module for transmitting the second music signal.

2. The device as claimed in claim 1, wherein the transmission module comprises:
a connecting interface; and
a transmission controller for controlling the connecting interface to access data.

3. The device as claimed in claim 2, wherein the connecting interface is a universal serial bus (USB) or an Institute of Electrical and Electronic Engineer 1394 (IEEE 1394) bus.

4. The device as claimed in claim 2, wherein the transmission controller is a USB OTG chip, a USB host controller or an IEEE 1394 control chip.

5. The device as claimed in claim 1, wherein the cigarette-lighter plug comprises:
a plug interface for plugging into the cigarette-lighter socket; and
a direct current (DC) voltage regulator for converting the first electric power acquired via the plug interface into a second electric power suitable for the MP3 broadcasting device.

6. The device as claimed in claim 1, wherein the playing module is an MP3 decoder.

7. The device as claimed in claim 1, wherein the FM radio module is an FM transmission chip.

8. The device as claimed in claim 1, wherein the electronic device has music files inside.

9. The device as claimed in claim 1, wherein the electronic device is a pen driver or an MP3 playing device.

10. The device as claimed in claim 1, further comprising a control module used to issue a command including play, stop, fast forward (FF), fast rewind (FR), repeat and random play.

11. The device as claimed in claim 1 further comprising a frequency-setting module for inputting a preset frequency into the FM radio module.
